(19) United States
(12) Patent Application Publication
(10) Pub. No.: US 2002/0147618 A1
(43) Pub. Date: Oct. 10, 2002

(54) Online insurance sales platform

(76) Inventors: Todd M. Mezrah, Tampa, FL (US); James D. Roberson, Coto De Caza, CA (US)

Correspondence Address: FOLEY AND LARDNER, SUITE 500, 3000 K STREET NW, WASHINGTON, DC, 20007, US

(21) Appl. No.: 10/060,276

(22) Filed: Feb. 1, 2002

Related U.S. Application Data
(60) Provisional application No. 60/265,328, filed on Feb. 1, 2001.

(51) Int. Cl. G06F 17/60

(52) U.S. Cl. 705/4

(57) ABSTRACT

A computer implemented method, system and software product for generating an online insurance sales platform. The method comprises the steps of: inputting user information into a first input form for Product Illustration and transferring the inputted information of the Product Illustration input form to an insurance carrier file; inputting user information into a second input form for Case Analysis and transferring that inputted information of the Case Analysis input form to an internal file; and inputting user information into a third input form for Report Production and transferring the inputted information of the Report Production marketing report.

### FIELD OF INVENTION

This invention relates generally to the field of insurance sales, and more particularly, to a method, system and software product for implementing an online insurance sales platform.

### BACKGROUND OF THE INVENTION

Life insurance is an important part of a person's feeling of security. It serves as a type of income assurance. The insured knows that if he or she were to pass away, the life insurance policy would provide a safety net for the beneficiaries, usually the insured's family.

It is common practice for insurance to be sold through an agent. Conventionally, an insurance agent acts as an intermediary between the customer and the actual life insurance provider. The agent usually receives a commission and must perform certain duties for both the customer and the insurance provider. For example, the agent must gather detailed information about the customer or party to be insured, including biographical information such as lifestyle and health conditions. The agent must also be responsive to the customer and be able to provide detailed information and personalized reports regarding the various insurance products the agent may be recommending. In addition, the agent must be able to communicate quickly and effectively with the various insurance providers the agent may represent. The agent must have some level of access to the insurance companies' products and systems used to generate policies in order to provide relevant and accurate information to the prospective customer. Ultimately, the agent must be able to provide good insurance options to the customer based on the information the agent is able to gather from both the customer and the insurance providers.

The inventors have identified certain drawbacks and inefficiencies in the above-described conventional method of insurance sales. Specifically, it generates a great deal of difficulty for the agent who must cope with differing requirements among the insurance companies the agent may represent. Some companies may require specific information about the party to be insured that other companies do not. Also, in order to access detailed and personalized information about insurance products, the agent may have to be familiar with many different processes for interfacing with and accessing information from the various insurance providers. If this access is provided over a communications network such as the Internet, the agent must also have certain technical acumen in order to communicate effectively with the different insurance providers' computer systems. Creation of reports for the customer can also be time consuming and inefficient when dealing with insurance products from different providers. In addition, agents often lack the resources and skills required to perform analysis on insurance values and integrate the results into a marketing presentation. All of these issues may result in a not insignificant cost to the agent, both in terms of time and convenience.

### SUMMARY OF INVENTION

Having identified the above-described problem, the inventors have developed the following solution, which is embodied in the present invention. The solution involves the creation and use of a sales platform through which an agent can efficiently and accurately choose the best insurance plan for each client according to each client's personal information and requests.

In one embodiment, the present invention provides a computer implemented method of generating an online insurance sales platform. The method includes the following steps: a) inputting user information into a first input form for Product Illustration; b) transferring the inputted information of the Product Illustration input form to an insurance carrier file; c) inputting user information into a second input form for Case Analysis; d) transferring the inputted information of the Case Analysis input form to an internal file; e) inputting user information into a third input form for Report Production; and f) transferring the inputted information of the Report Production input form, the Product Illustration input form and the Case Analysis input form into a generated marketing report.

In one aspect, the inputs of the Product Illustration input form are transferred to a product specific illustration engine provided by an insurance company.

In another aspect, the inputs of the Product Illustration input form are stored.

In yet another aspect, the illustration engines are used to calculate at least one of premiums, cash values, death benefits, loans, loan interests, withdrawals and account values.

In another aspect, the illustration engines are updated periodically.

In one aspect, the internal file is a Guru Engine for analyzing the inputs of the Case Analysis input form.

In another aspect, the inputs of the Case Analysis input form are stored.

In yet another aspect, the internal file is a file comprising an electronic spreadsheet.

In another aspect, an output from the transferred Case Analysis input form is in an HTML format.

In yet another aspect, the generated marketing report is a Microsoft Word file.

In yet another aspect, the Product Illustration step, comprising steps a) and b), is performed first, the Case Analysis step, comprising steps c) and d), is performed second, and the Report Production step, comprising steps e) and f) is performed third.

In yet another aspect, the Case Analysis step, comprising steps c) and d), is performed first, the Product Illustration step, comprising steps a) and b), is performed second, and the Report Production step, comprising steps e) and f), is performed third.

In another aspect, before the first inputting step, the present invention further comprises: inputting user identification to check for user status.

In yet another aspect, a search engine is accessed to determine appropriate forms and applications needed for a specific product.

In another aspect, the Case Analysis step, comprising steps c) and d), uses inputted user information from the Product Illustration input form to analyze an insurance product.

In yet another aspect, the Case Analysis step, comprising steps c) and d), uses inputted user information from the Product Illustration input form to make calculations based on the internal file used.

In another embodiment of the present invention, a computer program product having program code that is executable by a computer generating an online insurance sales platform, the program code is configured to cause the computer to perform the following steps: a) inputting user information into a first input form for Product Illustration; b) transferring the inputted information of the Product Illustration input form to an insurance carrier file; c) inputting user information into a second input form for Case Analysis; d) transferring the inputted information of the Case Analysis input form to an internal file; e) inputting user information into a third input form for Report Production; and f) transferring the inputted information of the Report Production input form, the Product Illustration input form and the Case Analysis input form into a generated marketing report.

In yet another embodiment of the present invention is a system for generating an online insurance sales platform, wherein the system includes a) a Product Illustration input form; b) a first transferor to transfer values from the Product Illustration input form to an insurance carrier file; c) a Case Analysis input form; d) a second transferor to transfer values from the Case Analysis input form to an internal file; e) a Report Production input form; and f) a third transferor to transfer values from the Report Production input form, the Product Illustration input form and the Case Analysis input form to a Generator to generate a marketing report.

In another embodiment of the present invention is a computer implemented apparatus for implementing an online insurance sales platform. The apparatus comprising: a) means for inputting user information into a first input form for Product Illustration; b) means for transferring the inputted information of the first input form to an insurance carrier file; c) means for inputting user information into a second input form for Case Analysis; d) means for transferring the inputted information of the Case Analysis input form to an internal file; e) means for inputting user information into a third input form for Report Production; and f) means for transferring the inputted information of the Report Production form, the Case Analysis input form and the Product Illustration input form into a generated marketing report.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a flow chart illustrating the preferred method of the present invention.

FIG. 2 is a flow chart illustrating the method of the Product Illustration step according to a preferred embodiment of the present invention.

FIG. 3 is a flow chart illustrating the method of the Case Analysis step according to a preferred embodiment of the present invention.

FIG. 4 is a flowchart illustrating the method of the Report Production step according to a preferred embodiment of the present invention.

FIG. 5 is a diagram illustrating an example of an input form for the Product Illustration step of the present invention.

FIG. 6 is a diagram illustrating an example of an input form for the Case Analysis step of the present invention.

FIG. 7 is a diagram illustrating an example of an input form for the Report Production step of the present invention.

FIG. 8 is a diagram illustrating an example of a Case File page of the present invention.

FIG. 9 is a block diagram showing the system components of a preferred embodiment of the present invention.

### DETAILED DESCRIPTION OF THE PREFERRED EMBODIMENTS

As described herein with reference to the accompanying drawings, the present invention provides a method, system and software product for implementing an online insurance sales platform.

A general purpose computer system can be connected to an electronic network, such as a computer network. The computer network can also be a public network, such as the Internet or Metropolitan Area Network (MAN), or other private network, such as a corporate Local Area Network (LAN) or Wide Area Network (WAN), a virtual private network, or an Intranet. The computer system includes a central processing unit (CPU) connected to a system memory. The system memory typically contains an operating system, a BIOS driver, and application programs. In addition, the computer system contains input devices such as a mouse and a keyboard, and output devices such as a printer and a display monitor.

The computer system generally includes a communications interface, such as an Ethernet card, to communicate to the electronic network. Other computer systems may also be connected to the electronic network. One skilled in the art would recognize that the above system describes the typical components of a computer system connected to an electronic network. It should be appreciated that many other similar configurations are within the abilities of one skilled in the art and all of these configurations could be used with the methods of the present invention.

In addition, one skilled in the art would recognize that the “computer” implemented invention described further herein may include components that are not computers per se but include devices such as Internet appliances and Programmable Logic Controllers (PLCs) that may be used to provide one or more of the functionalities discussed herein. Furthermore, the term “electronic” networks is intended to refer generically to the communications network connecting the processing sites of the present invention, including electronic implementations, but also encompassing optical or other equivalent technologies.

One skilled in the art would recognize that other system configurations and data structures and electronic/data signals could be provided to implement the functionality of the present invention. All such configurations and data structures are considered to be within the scope of the present invention.

The present invention provides an effective and efficient way to select an appropriate insurance plan using various selection processes. For example, the present invention is beneficial to insurance carriers, financial institutions and financial service providers. Since the present invention can operate online, this allows clients to control, manage and track their own personal accounts.

The present invention comprises, in one embodiment, two sides that are connected to each other over a network. The first side is the server side, where a platform with running software is used to implement the method of the present invention. The second side is the client side which comprises computers used to select and view various insurance options from various insurance carriers.

The server side and the client side are connected, in a preferred embodiment, over the internet. Users enter information asked of them on the client side of the network. The entered information is transmitted over the network to the server side. The server side is also connected to a variety of insurance carrier systems. Once the required information is entered on the client side and transmitted over to the server side, the server side processes the information and connects with the appropriate insurance carrier computer. When the communication between the server side and the insurance carrier computer is completed, the results of the process are transmitted through the network back to the client side.

The server side also has databases. In the databases, specific inputted values extracted from the entered information from the client computers are stored to be used later on in the method of the present invention.

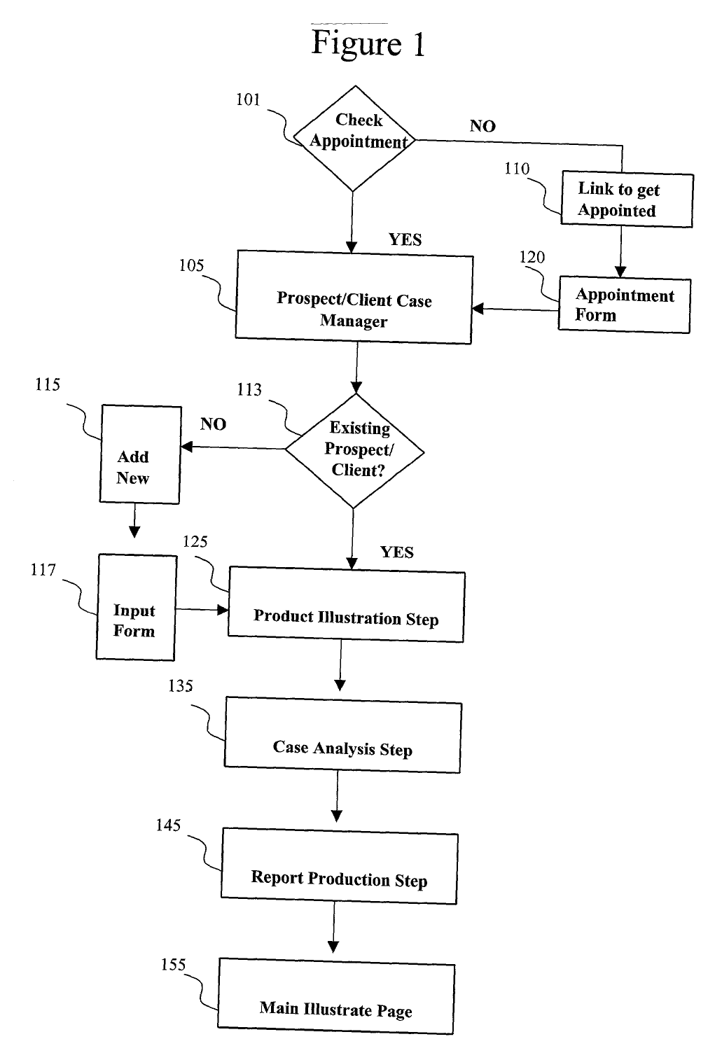

Referring now to the drawings, FIG. 1 is a flow chart illustrating a preferred embodiment of the method of the present invention. In this description, the “user” of the invention is the insurance agent. The appointment process is the first step of the method of the present invention. To be “appointed” means a user has been approved to access one or more systems of an insurance carrier. The user may distribute insurance from and obtain information about an insurance carrier for which the user is appointed. A user may be appointed to a few insurance carriers, but not necessarily to all of them. If the user has to be connected to a specific insurance carrier, the user must receive positive validation for being appointed with that insurance carrier. In step 101, the user enters in an identifying code, e.g., a social security number, to determine whether or not the user is appointed. The system processes the data and then determines whether or not the user is appointed. If the user is not appointed, then the user is linked in step 110 to an appointment form where the user may get appointed. After the user clicks on the link, in step 120, the user is directed to the appropriate carrier's appointment form, a form that contains information regarding the appointment process and information about that particular insurance carrier. The user completes the form to begin the appointment process. The appointment process can be implemented a number of ways. For example, certain insurance carriers request that the Appointment form be sent directly to them for their review before granting the requesting user an “appointed” status.

If the user is appointed in step 101, or if the user gets appointed by steps 110 and 120, then in step 105, the user is taken directly to a Prospect/Client Case Manager. In step 113, the user has a choice of selecting an existing prospect/client or creating a new prospect/client under a new prospect/client folder.

If the user wants to create and save a new prospect/client to the Case Manager, the user may do so in step 115 by selecting an option to add a new Prospect/Client. In step 117, the user is then taken to an input form where the user types in the name of his or her prospect. This information is then saved as the name of the main prospect folder.

The user can also select an option to add in a new case file in either an existing prospect folder or a new prospect folder. When the user selects the option to add in a new case file to a prospect folder, the user enters in a description of the Case File and then makes a series of selections to determine an appropriate template to run through the process of the present invention. An example of the selections made includes the Case Type (e.g. Business Planning). As the user makes selections, the selections are tracked at each step while building the Case File.

The templates are custom made for each insurance product, for each client and/or prospect. The templates are built or selected based on the series of selections made by the user when building the Case File. In the Product Illustration step, the Case Analysis step and the Report Production step, the selected template decides which input forms will be used to obtain information from the user. Each product will have a unique input form. In the Product Illustration step, the template chooses the insurance product that will be illustrated. In the Case Analysis step, the created template designates for the system which internal file, preferably which Guru Engine, to use. In the Report Production step, the template chooses which files are needed to generate the marketing report.

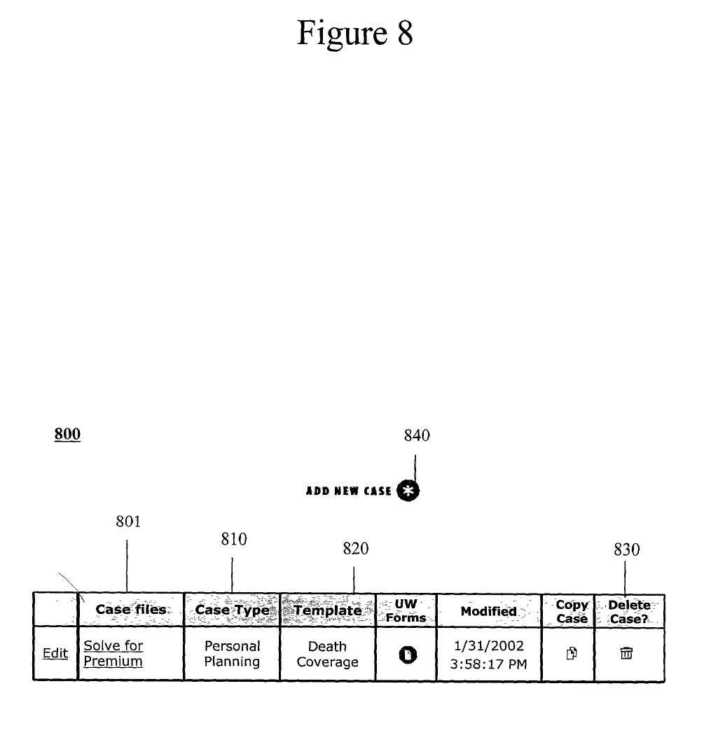

Once a Case File has been created, it can be found in the Prospect/Client folder. An example of a Case File page is found in FIG. 8, element 800. On the Case File page 800, a description 801 of the Case File is shown, as are the Case type 810 the main template used 820 and an option to delete the Case File 830. A new Case File can also be added onto this page by selecting an Add New Case File option 840.

At the end of the selection process of creating a new Prospect/Client folder or if the user selects an existing Prospect/Client folder in the first place, the user is taken to the Product Illustration step 125. After the Product Illustration step 125, the user is taken to the Case Analysis step 135. After which, the user is taken to the Report Production step 145. The order of the Product Illustration step 125 and the Case Analysis step 135 may be reversed or otherwise altered depending on the specific situation. At the end of the Report Production step 145, the user is taken back to the main Illustrate page 155. In some cases the Product Illustration step 125 is the first step, in other cases, the Product Illustration step 125 is the second step. Both ways are accepted and functional.

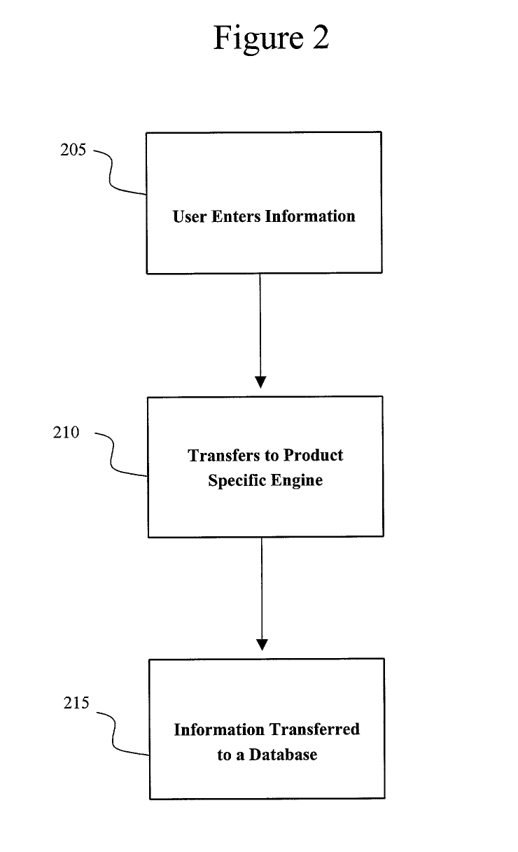

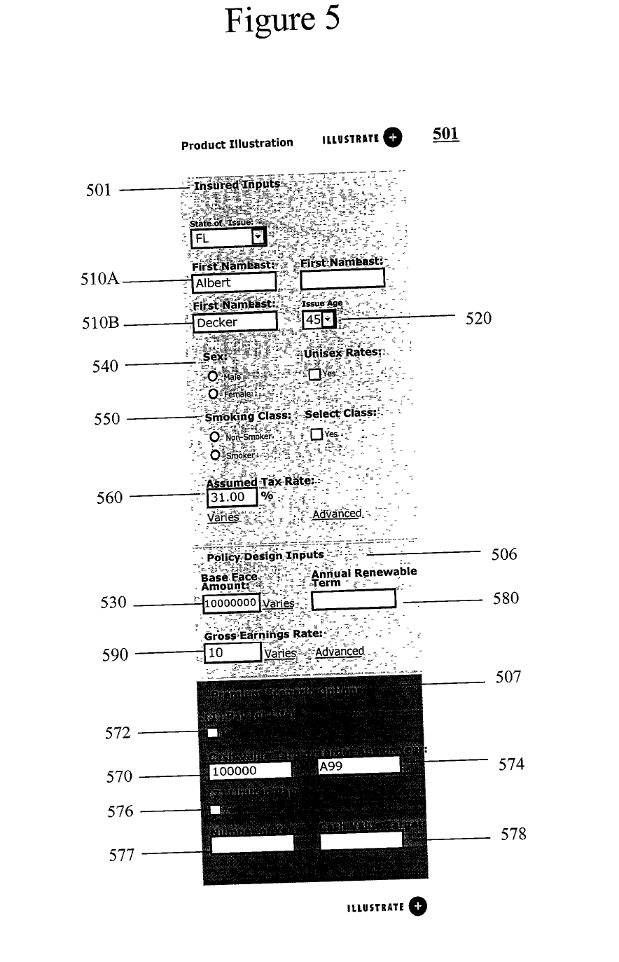

FIG. 2 is a flow chart illustrating, in more detail, the method of the Product Illustration step 125 according to a preferred embodiment of the present invention. In step 205, the user enters information into the Product Illustration input form. The Product Illustration input form asks the user for inputs required to run an insurance illustration. One example of such a form is shown in FIG. 5, element 501. The Product Illustration input form 501 may be divided into three sections: Insured Inputs 505, Policy Design Inputs 506 and Premium Scenario Options 507. Inputs in the Insured Inputs section 505 may include the user's name 510A and 510B, age 520, sex 540, whether or not the user is a smoker 550 and assumed tax rate 560. The Policy Design Inputs section 506 may include a base face amount 530, annual renewable term 580 and a gross earning rate 590. The Premium Scenario Options section 507 may include an option to be paid for life 572, a cash value target 570, a target age or year 574, an option for limited pay 576, and number of years 577 and cash value target 578 for limited pay 576. In step 210, the information entered in the Product Illustration input form 501 is transferred to a product specific illustration engine.

The product specific illustration engine can be either at an insurance carrier's site, on the system of the present invention, or at another convenient location. The location of the product specific illustration engine is dependent on the policies and requests of the insurance carriers themselves. The connection to and from the insurance carrier is through a network, preferably the internet.

After the inputs are transferred to the product specific illustration engine in step 210, the illustration engine is invoked. As the Product Illustration Step 125 is processing, raw values from the information entered in the Product Illustration input form 501 are sent to a database 930, in step 215, to be used at a later time for generation of a marketing report.

In another embodiment, after the user enters in the information in the Product Illustration input form in step 205, the inputs go through a process of validation. This insures that all the inputs fit within parameters available for that product. For example, if the user enters in a death benefit of $15 million and that particular product only has a death benefit maximum of $10 million, then the system takes the user back to the original step and asks the user to re-enter a value less than or equal to $10 million.

The product illustration engines are used to calculate at least one of premiums, cash values, death benefits, loans, loan interests, withdrawals and account values for various life insurance products. These programs can calculate life insurance values given various ages, death benefit amounts and premiums and are well known in the art.

The product illustration engines are provided by or accessed directly from the life insurance carriers and are updated periodically with revised diskettes or with other methods.

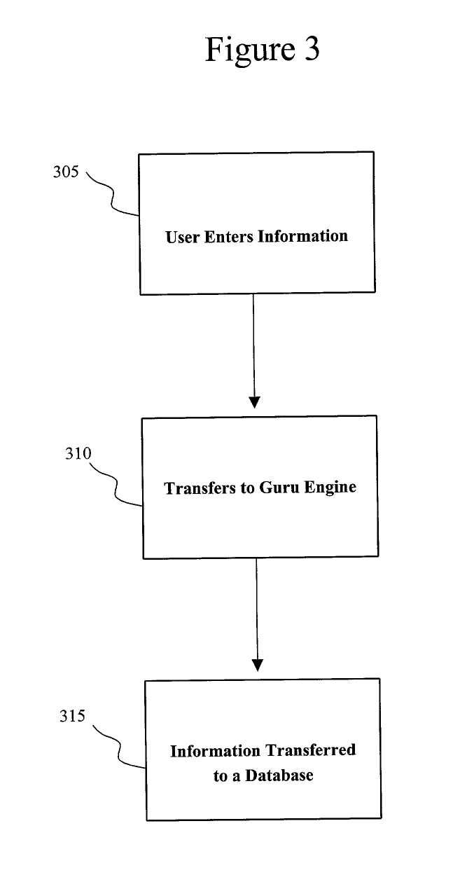

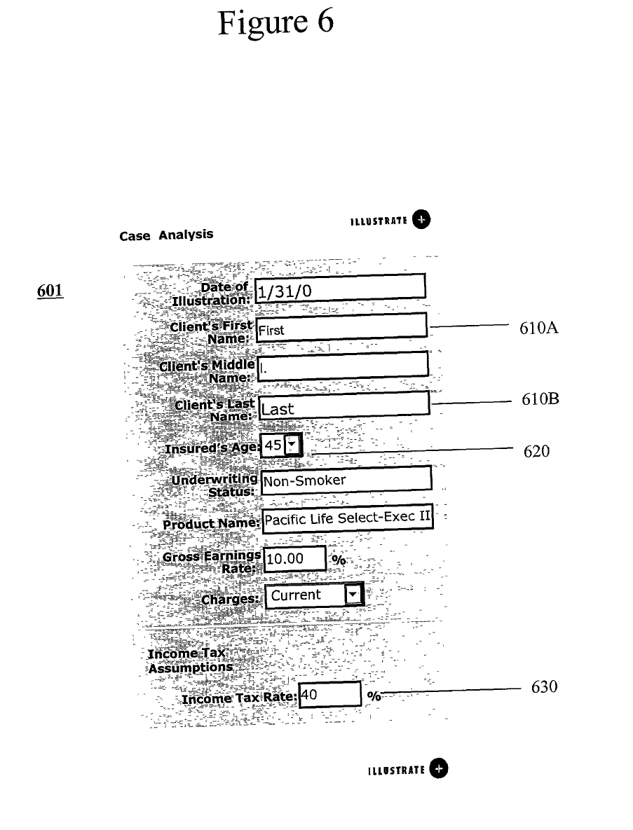

FIG. 3 is a flow chart illustrating, in more detail, the Case Analysis step according to a preferred embodiment of the present invention. In step 305, the user enters information into the Case Analysis input form. The Case Analysis input form may require inputs used to analyze the insurance product. One example of such a form is shown in FIG. 6, element 601. The Case Analysis input form 601 may ask the user for inputs such as the insured's first and last name 610A and 610B. Other examples of possible inputs may be the insured's age 620 and the insured's income tax rate 630. In step 310, the information entered into the Case Analysis input form 601 is transferred to an internal file. In a preferred embodiment, the internal file is a Guru Engine. One possible embodiment of the Guru Engine is an electronic spreadsheet such as a Microsoft Excel file running on an internal server. Once the information has been transferred, in a preferred embodiment, to the Excel file, the Excel macro is invoked.

Each Guru Engine contains formulas and macros within the electronic spreadsheet. The electronic spreadsheet on the server runs the macro and then presents the results in a different non-spreadsheet formatted page. In a preferred embodiment, the Guru Engines contain the formulas and macros with an Excel file, and then the results are presented in an HTML formatted page.

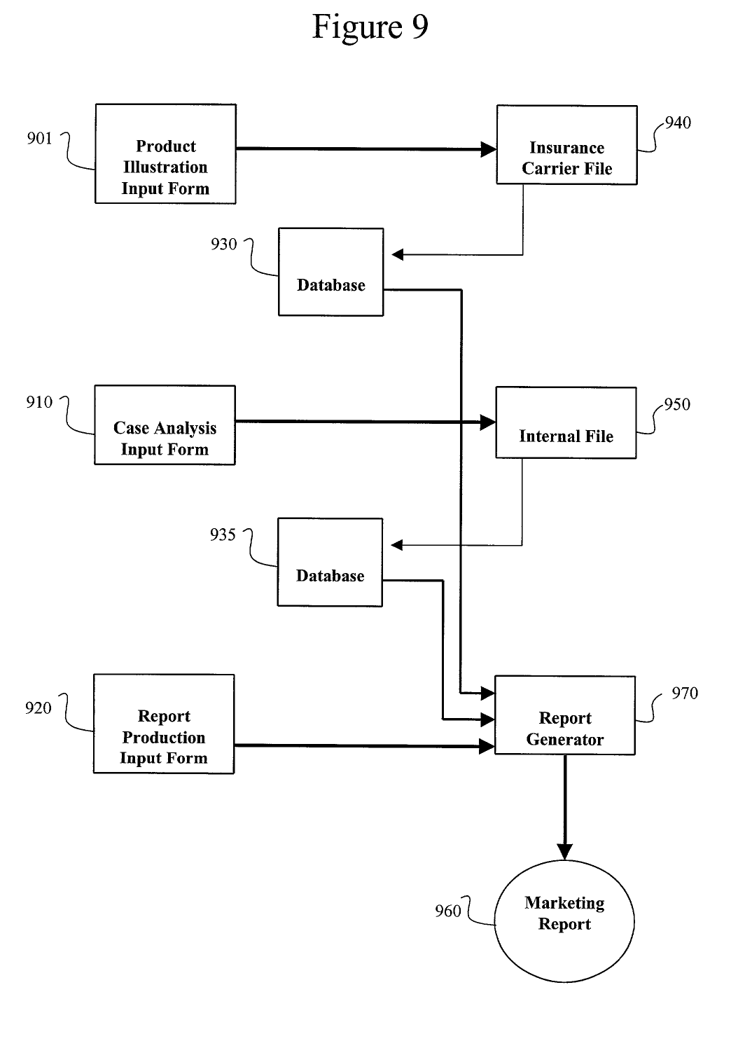

As the Case Analysis step 135 is processing, the raw values from the electronic spreadsheet are extracted and sent to a database 935 (See FIG. 9), in step 315, to be used at a later time. The user can run multiple scenarios for a given prospect or case file. The results from each scenario are stored individually in the database 935. In a preferred embodiment, an HTML output is generated from the Excel file.

Case analysis allows for a user to model benefit figures for deferred compensation plans, supplemental retirement plans, split dollar plans, etc. The designing of plans (i.e. cases) is done in minutes as opposed to days, which is how long it takes conventional techniques.

A number of Guru Engines are used to perform Case Analysis in this process. These Guru Engines, in the preferred embodiment, are Microsoft Excel files that are invoked and that run on the server. Some Guru Engines include:

| | |
|---|---|
| For Business Planning: | Key Man Guru, Buy-Sell Guru |
| For Charitable Planning: | Wealth Replacement Guru |
| For Estate Planning: | Company Split-Dollar Guru, Private Split- |
| | Dollar Guru, Death Coverage Guru, Wealth |
| | Transfer Guru and Benefit Restructure Guru. |
| For Personal Planning: | Private Plan Guru, Death Coverage Guru, |
| | Separate Account Guru and Variable Annuity |
| | Guru. |
| For Executive Planning: | 162 Bonus Guru, Group Term Carve Out Split- |
| | Dollar Guru, Benefit Restructure Guru, |
| | Deferred Compensation Guru, Supplemental |
| | Executive Retirement Plan Guru, Executive |
| | Loan Guru and Equity Split-Dollar Guru. |
| For General Use: | Insurance Compositor Guru and IRR Guru. |

A description of some of the Guru Engines is provided below.

Benefit Restructure—Cash Compensation Guru Engine:

Calculates the insurance premium that makes the present value of cash compensation and a split-dollar benefit equal. It also includes the effect of gift and estate taxes on the executive as well as the present value cost to the company. It also incorporates executive reinvestment of cash in a managed portfolio.

This Guru Engine outputs a company cash flow, company income statement and executive impact. The internal rate of return and the potential taxation of the transaction are also calculated.

Deferred Compensation Guru Engine:

Calculates deferred compensation plan liability for one or more executives. This engine can also produce values based on a pure non-qualified plan, non-qualified a excess plan or qualified 401(k) plan. This engine incorporates company match, qualified plan limits with escalation, salary scale and mortality adjusting. The company cash flow and income statement is output.

Estate Tax Guru Engine:

This Guru Engine calculates: Estate Tax Due at Time of Death, Capital Gains Tax Upon Liquidation at Various Times, and Total Estate and Capital Gains Tax, under both the current and recent proposed Estate Tax legislation.

Insurance Compositor Guru Engine:

This Guru Engine allows multiple insurance illustrations to be composited into single group values. This displays cumulative premiums, loans, loan interest, withdrawals, cash value and death benefit. This Engine performs mortality adjusting based on a variety of mortality tables. Company cash flow and the income statement is output.

IRR Guru Engine:

This Engine calculates the insurance death benefit and cash value internal rate of return for each year, from year of purchase to year of death.

Separate Account Ledger Guru Engine:

This Guru Engine takes unsightly insurance illustration output and reformats it into user-friendly output. It calculates tax due upon policy surrender and formats up to three different insurance runs at one time.

Fixed Account Ledger Guru Engine:

Takes unsightly insurance illustration output and reformats it into user-friendly output. It calculates tax due upon policy surrender and formats up to three different insurance runs at one time.

Managed Portfolio Guru Engine:

It calculates accumulated values and withdrawal amounts from a managed portfolio. It incorporates variables such as dividend yield, commission, capital gains tax and ordinary income tax. It calculates taxes on realized gains and income.

Private Plan Guru Engine:

This Guru Engine takes unsightly insurance illustration output and reformats it into a user-friendly output. It calculates tax due upon policy surrender and displays withdrawals and loans from policy that make up total after-tax income from insurance policy.

Equity Split-Dollar Guru Engine:

This Engine displays split-dollar illustration in a user-friendly format with separate output for premium payer and policy owner. It calculates imputed income, net present values and rollout. This engine illustrates potential tax treatment of the transaction including Section 83 income and gift tax.

Variable Annuity Guru Engine:

This Guru Engine compares financial outcome of purchasing a variable annuity versus a managed portfolio. It includes accumulation analysis, annuitization analysis and a withdrawal analysis. It incorporates mortality and expense charges, annuitization tax, loads and fees, dividend yield and capital gains tax.

It would be apparent to one of ordinary skill in the art that any number of Guru Engines could be used with the present invention and that the above mentioned ones are merely a sample. The present invention is not limited by the design or characteristics of any specific Guru Engine.

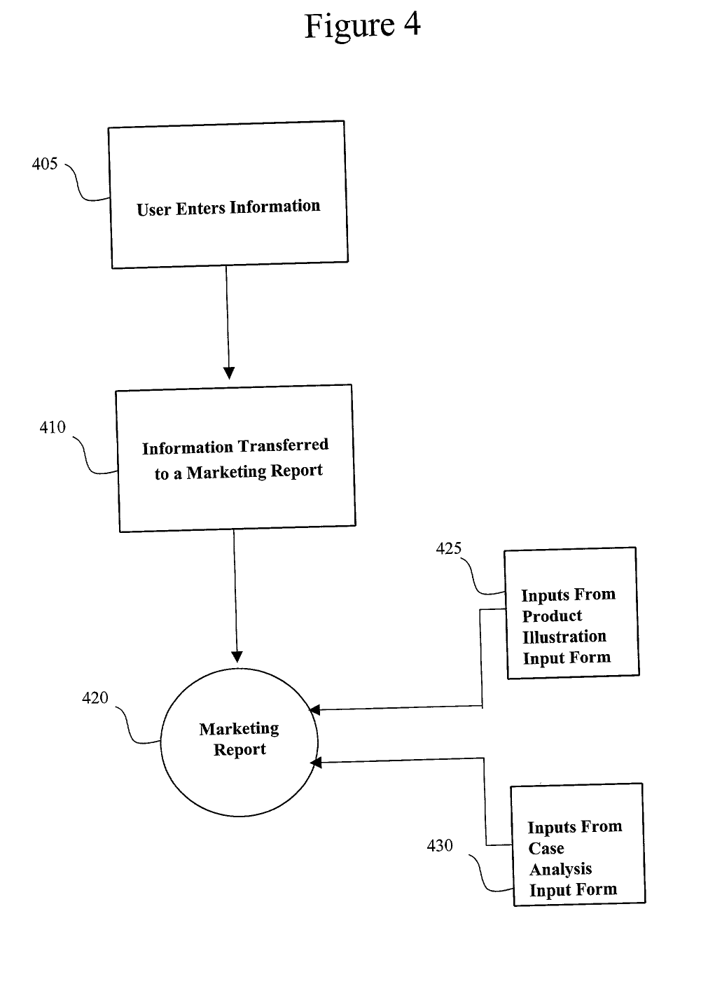

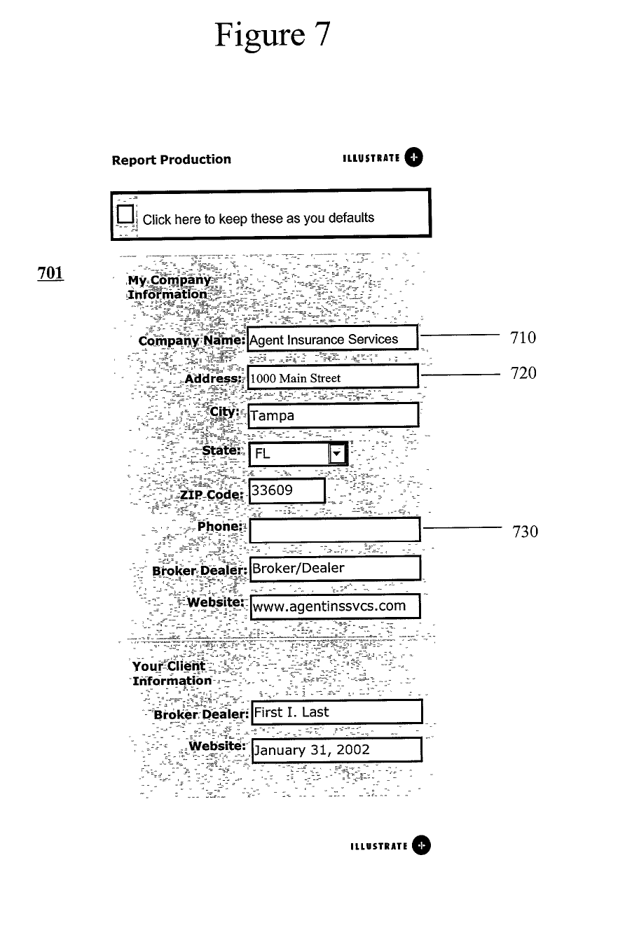

FIG. 4 is a flow chart illustrating, in more detail, the Report Production step 145 according to a preferred embodiment of the present invention. The Report Production input form primarily asks the user for information relating to labeling features for the marketing report. One example of such a form is shown in FIG. 7, element 701. For example, the information required may be a name of a company 710, address of the company 720, and a phone number 730. In step 405, the user inputs information in the Report Production input form 701. In step 410, the information entered in the form 701 is transferred into a generated marketing report, preferably a Microsoft Word file. In steps 425 and 430, the raw values from the Product Illustration step 125 and the raw values from the Case Analysis step 135, respectively, which are stored in databases 930 and 935, respectively, are transferred into the marketing report 420. Therefore, the marketing report 420 comprises three sets of inputs.

FIG. 9 is a block diagram illustrating the system components of a preferred embodiment of the present invention. The Product Illustration input form 901 is either the first form or the second form to be filled out by the user. The Case Analysis input form 910 is either the first form or the second form to filled out by the user. When the Product Illustration input form 901 has been filled out, the information entered in form 901 is transferred to an Insurance Carrier File 940, preferably a Product Specific Engine. The raw values extracted from the information are transferred for storage to a database 930. When the Case Analysis input form 910 has been filled out by the user, the information entered in form 910 is transferred to an internal file 950. In one embodiment, the internal file 950 is a Guru Engine, or an electronic spreadsheet. The raw values extracted from that information are transferred for storage to a database 935. When the Report Production input form 920 has been filled out by the user, the information of form 920 is transferred to a Report Generator 970. The raw values that are stored in the database 930 and the database 935 are also sent to the Report Generator 970, which then generates a Marketing Report 960, using the raw values from the database 930, the database 935, and the inputted information from the Report Production input form 920.

Another feature of the present invention is its Underwriting aspect. The Underwriting aspect serves as a search engine by providing users with the ability to search the appropriate carrier forms or to utilize Artificial Intelligence to determine the appropriate forms based on the case facts. The Artificial Intelligence has a variety of questions in varying levels to determine an appropriate match for the appropriate plan and also finds the forms and applications that are required according to the plan that was chosen using the Artificial Intelligence.

Once the Artificial Intelligence has made its selections, the user is presented with a diagram of the answers and results. The results can be broken down into a number of categories. For example, one category may be Required Insurance Applications and Forms and the other may be Supplemental Insurance Applications and Forms.

Other embodiments of the present invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A computer implemented method of generating an online insurance sales platform, the method comprising the steps of:
a) inputting user information into a first input form for Product Illustration;
b) transferring the inputted information of the Product Illustration input form to an insurance carrier file;
c) inputting user information into a second input form for Case Analysis;
d) transferring the inputted information of the Case Analysis input form to an internal file;
e) inputting user information into a third input form for Report Production; and
f) transferring the inputted information of the Report Production input form, the Product Illustration input form and the Case Analysis input form into a generated marketing report.

2. The method according to claim 1, wherein the inputs of the Product Illustration input form are transferred to a product specific illustration engine provided by an insurance company.

3. The method according to claim 1, wherein the inputs of the Product Illustration input form are stored.

4. The method according to claim 2, wherein the illustration engines are used to calculate at least one of premiums, cash values, death benefits, loans, loan interests, withdrawals and account values.

5. The method according to claim 2, wherein the illustration engines are updated periodically.

6. The method according to claim 1, wherein the internal file is a Guru Engine for analysis.

7. The method according to claim 1, wherein inputs of the Case Analysis input form are stored.

8. The method according to claim 1, wherein the internal file is a file comprising an electronic spreadsheet.

9. The method according to claim 1, wherein an output from the transferred second input form is in an HTML format.

10. The method according to claim 1, wherein the generated marketing report is a Microsoft Word file.

11. The method according to claim 1, wherein the Product Illustration step, comprising steps a) and b), is performed first, the Case Analysis step, comprising steps c) and d), is performed second, and the Report Production step, comprising steps e) and f) is performed third.

12. The method according to claim 1, wherein the Case Analysis step, comprising steps c) and d), is performed first, the Product Illustration step, comprising steps a) and b) is performed second, and the Report Production step, comprising steps e) and f), is performed third.

13. The method according to claim 1, wherein a search engine is accessed to determine appropriate forms and applications needed for a specific product.

14. The method according to claim 1, wherein the Case Analysis step, comprising steps c) and d), uses inputted user information from the Product Illustration input form to analyze an insurance product.

15. The method according to claim 1, wherein the Case Analysis step, comprising steps c) and d), uses inputted user information from the Product Illustration input form to make calculations based on the internal file used.

16. A computer program product having program code that is executable by a computer for generating an online insurance sales platform, the program code configured to cause the computer to perform the following steps:
a) inputting user information into a first input form for Product Illustration;
b) transferring the inputted information of the Product Illustration input form to an insurance carrier file;
c) inputting user information into a second input form for Case Analysis;
d) transferring the inputted information of the Case Analysis input form to an internal file;
e) inputting user information into a third input form for Report Production; and
f) transferring the inputted information of the Report Production input form, the Product Illustration input form and the Case Analysis input form into a generated marketing report.

17. The program product according to claim 16, wherein the inputs of the first input form for Product Illustration are transferred to a product specific illustration engine provided by an insurance company.

18. The program product according to claim 16, wherein the inputs of the Product Illustration input form are stored.

19. The program product according to claim 17, wherein the illustration engines are used to calculate at least one of premiums, cash values, death benefits, loans, loan interests, withdrawals, and account values.

20. The program product according to claim 17, wherein the illustration engines are updated periodically.

21. The program product according to claim 16, wherein the internal file is a Guru Engine analysis.

22. The program product according to claim 16, wherein inputs of the Case Analysis input form are stored.

23. The program product according to claim 16, wherein the internal file is a file comprising an electronic spreadsheet.

24. The program product according to claim 16, wherein an output from the transferred Case Analysis input form is in an HTML format.

25. The program product according to claim 16, wherein the generated marketing report is a Microsoft Word file.

26. The program product according to claim 16, wherein the Product Illustration step, comprising steps a) and b), is performed first, the Case Analysis step, comprising steps c) and d), is performed second, and the Report Production step, comprising steps e) and f), is performed third.

27. The program product according to claim 16, wherein the Case Analysis step, comprising steps c) and d) is performed first, the Product Illustration step, comprising steps a) and b) is second, and the Report Production step, comprising steps e) and f), is third.

28. The program product according to claim 16, wherein a search engine is accessed to determine appropriate forms and applications needed for a specific product.

29. A system for generating an online insurance sales platform, the system comprising:
a) a Product Illustration input form;
b) a transferor to transfer values from the Product Illustration input form to an insurance carrier file;
c) a Case Analysis input form;
d) a second transferor to transfer values from the Case Analysis input form to an internal file;
e) a Report Production input form;
f) a third transferor to transfer values from the Report Production input form, the Product Illustration input form and the Case Analysis input form to a generated marketing report.

30. A computer implemented apparatus for implementing an online insurance sales platform, the apparatus comprising:
means for inputting user information into a first input form for Product Illustration;
means for transferring the inputted information of the Product Illustration input form to an insurance carrier file;
means for inputting user information into a second input form for Case Analysis;
means for transferring the inputted information of the Case Analysis input form to an internal file;
means for inputting user information into a third input form for Report Production; and
means for transferring the inputted information of the Report Production input form, the Product Illustration input form and the Case Analysis input form into a marketing report.

31. The method according to claim 1, further comprising, before the first inputting step, inputting user identification to check for user status.

32. The program product according to claim 16, wherein before the first inputting step, the computer performs the step of inputting user identification to check for user status.
